(19) United States
(12) Patent Application Publication
(10) Pub. No.: US 2025/0084681 A1
(43) Pub. Date: Mar. 13, 2025

(54) MAGNETICALLY ACTIVATED MECHANICAL DOORSTOP

(71) Applicant: VERUM ITALY S.R.L., Bulciago (IT)

(72) Inventor: Umberto Vergani, Bulciago (IT)

(73) Assignee: VERUM ITALY S.R.L., Bulciago (IT)

(21) Appl. No.: 18/728,287

(22) PCT Filed: Jan. 2, 2023
(86) PCT No.: PCT/IT2023/050001

§ 371 Date: Jul. 11, 2024

(30) Foreign Application Priority Data
Jan. 18, 2022 (IT) 102022000000740

(51) Int. Cl. E05C 19/16; E05B 47/00; E05B 63/20; E05C 19/02

(52) U.S. Cl. CPC E05C 19/163; E05B 47/004; E05B 63/20; E05C 19/02

(57) ABSTRACT

A magnetically activated mechanical doorstop (1) is described comprising: a pin (3) installed in a hollow element (5) operatively connected to a door (7); a magnetic element (9) operatively connected to a jamb (11) and designed to attract and block the pin (3) by magnetic force when the door (7) is in its closed operative position, the magnetic element (9) being furthermore designed to bring the door (7) to its open operating position when the magnetic attraction between the pin (3) and the magnetic element (9) ceases and the pin (3) falls back by gravity into the hollow element (5), in which the pin (3) is free to move horizontally and vertically in the hollow element (5), and the magnetic element (9) installed in the jamb (11) has a horizontally elongated recess (13) suitable for doors with opening to push and pull in both directions, the recess (13) being able to house the pin (3) during the closing phase of the door (7).

The present invention refers to a magnetically activated mechanical doorstop.

Object of the present invention is providing a magnetically activated mechanical doorstop which allows the door to be locked in one direction in a clear and precise manner, while still leaving the possibility of adjustment.

Another object of the present invention is allowing the element to be correctly repositioned in the jamb in the event of excessive resistance from the mechanical doorstop during the door opening phase.

The above and other objects and advantages of the invention, as will appear from the following description, are achieved with a magnetically activated mechanical doorstop as described in claim 1. Preferred embodiments and non-trivial variants of the present invention form the subject matter of the dependent claims.

It is understood that all attached claims form an integral part of the present description.

It will be immediately obvious that innumerable variations and modifications may be made to what has been described (for example relating to shape, dimensions, arrangements and parts with equivalent functions) without departing from the scope of protection of the invention as appears from the attached claims.

The present invention will be better described by some preferred embodiments, provided by way of non-limiting example, with reference to the attached drawings, in which:

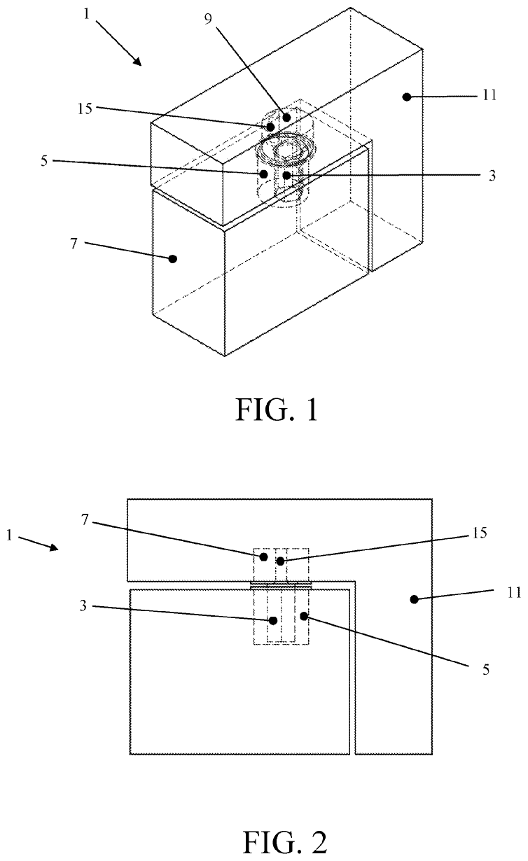

FIG. 1 shows a perspective view of an embodiment of the magnetically activated mechanical doorstop according to the present invention;

FIG. 2 shows a front view of an embodiment of the magnetically activated mechanical doorstop according to the present invention;

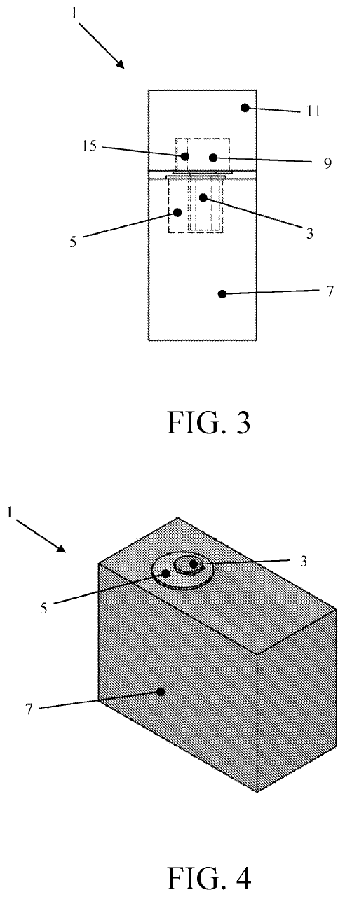

FIG. 3 shows a side view of an embodiment of the magnetically activated mechanical doorstop according to the present invention;

FIG. 4 shows a perspective view of one embodiment of the hollow member and pin of the magnetically activated mechanical door stop installed in the door according to the present invention;

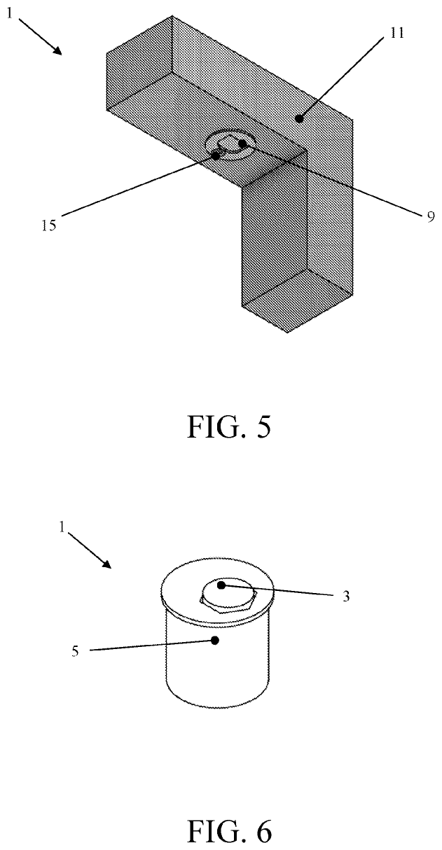

FIG. 5 shows a perspective view of an embodiment of the magnetic element of the magnetically activated mechanical doorstop installed in the jamb according to the present invention;

FIG. 6 shows a detail of an embodiment of the hollow element and of the pin of the magnetically activated mechanical doorstop according to the present invention;

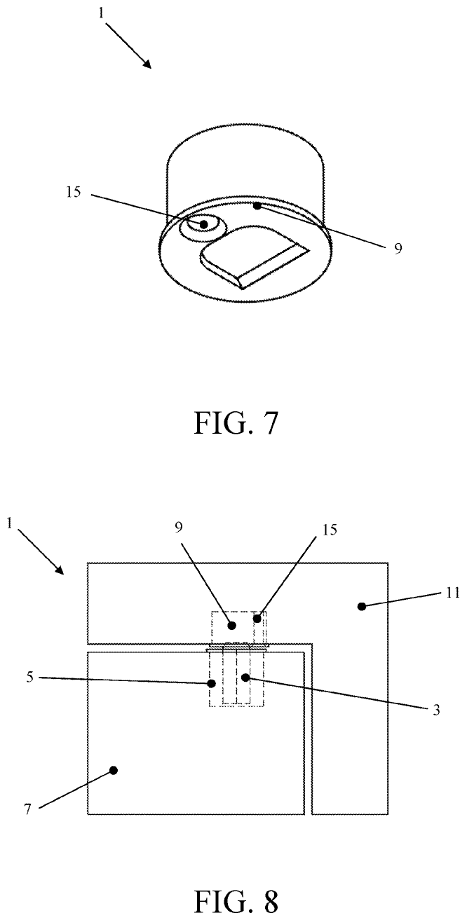

FIG. 7 shows a detail of an embodiment of the magnetic element of the magnetically activated mechanical doorstop according to the present invention;

FIG. 8 shows a front view of an embodiment of the magnetically activated mechanical doorstop for doors with push and pull opening in both directions according to the present invention;

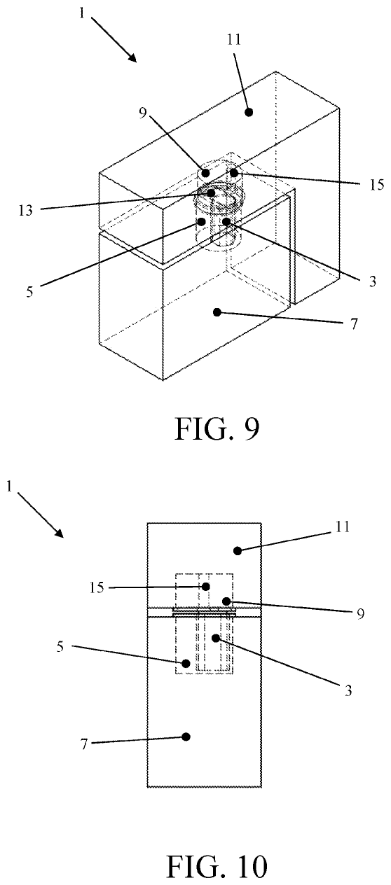

FIG. 9 shows a perspective view of an embodiment of the magnetically activated mechanical doorstop for doors with push and pull opening in both directions according to the present invention;

FIG. 10 shows a side view of an embodiment of the magnetically activated mechanical doorstop for doors with push and pull opening in both directions according to the present invention;

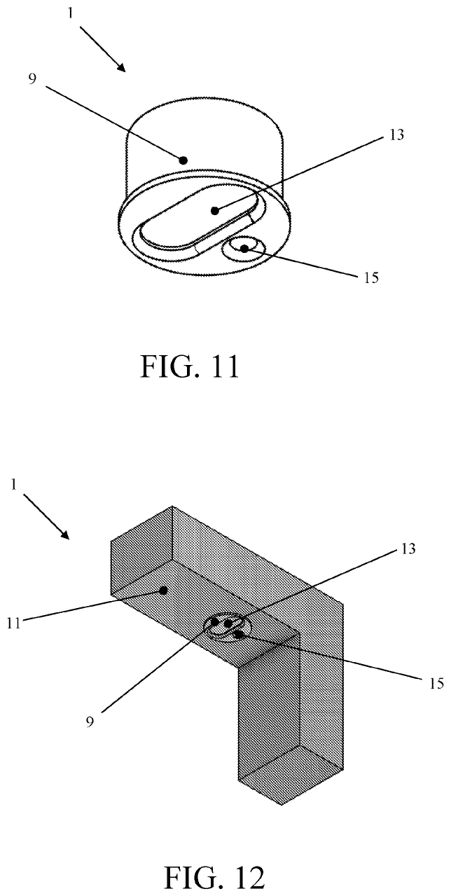

FIG. 11 shows a detail of an embodiment of the magnetic element with the recess for doors with push and pull opening in both directions of the magnetically activated mechanical doorstop according to the present invention;

FIG. 12 shows a perspective view of an embodiment of the magnetic element of the magnetically activated mechanical doorstop for doors with push and pull opening in both directions installed in the jamb according to the present invention.

The present invention consists of a magnetically activated mechanical doorstop 1 comprising:
at least one pin 3 installed in a hollow element 5, the hollow element 5 beking operatively connected to a door 7;
at least one magnetic element 9 operatively connected to a jamb 11.

Advantageously, the magnetic element 9 is designed to attract and block the pin 3 by magnetic force when the door 7 is in its closed operating position.

Furthermore, the magnetic element 9 is designed to bring the door 7 to its open operating position when the magnetic attraction between the pin 3 and the magnetic element 9 ceases; subsequently, the pin 3 falls back by force of gravity in the hollow element 5.

The magnetically activated mechanical doorstop 1 according to the present invention consists of two round elements for which the same hole with a diameter of 20 mm is made in the door 7 and in the jamb 11.

In particular, a cylindrical magnetic pin 3 is inserted in the hollow element 5 in the door 7: this pin 3 is also free to move vertically inside the hollow element 5.

Advantageously, by means of an Allen key, it is possible to rotate the hollow element 5 by adjusting it both laterally and in depth.

Furthermore, in a variation of the magnetically activated mechanical doorstop of the invention, the magnetic element 9 has a recess 13 externally designed to attract and block the pin 3 present in the door 7 panel when it is closing for doors with push and pull opening in both directions.

Advantageously, the magnetically activated mechanical doorstop 1 therefore allows the door 7 to be locked in one direction in a clear and precise manner, while still leaving the possibility of adjustment.

During assembly, excessive resistance will indicate incorrect installation, thus allowing the magnetic element 9 to be correctly repositioned in the jamb 11.

Furthermore, the magnetic element 9 can be operatively connected to the jamb 11 by means of at least one screw 15.

What is claimed is:

1. A magnetically activated mechanical doorstop comprising:
at least one pin installed in a hollow element, the hollow element being operatively connected to a door;
at least one magnetic element operatively connected to a jamb;
the magnetic element being designed to attract and lock the pin by magnetic force when the door is in its closed operating position;
the magnetic element being furthermore designed to bring the door to its open operative position when the magnetic attraction between the pin and the magnetic element ceases and the pin falls back by force of gravity in the hollow element,
wherein the pin is free to move horizontally and vertically in the hollow element, and the magnetic element installed in the jamb has a horizontally elongated recess suitable for doors with push and pull opening in both directions, the recess being able to house the pin during a closing phase of the door.

2. The mechanical doorstop of claim 1, wherein the mechanical doorstop is designed to be adjustable allowing to change its position after installation.

3. The mechanical doorstop of claim 1, wherein the magnetic element is operatively connected to the jamb by means of at least one screw.
